(19) United States
(12) Patent Application Publication
(10) Pub. No.: US 2026/0057671 A1
(43) Pub. Date: Feb. 26, 2026

(54) ARTIFICIAL INTELLIGENCE DRIVEN INVENTORY, PERSONNEL, HOSPITALITY, AND CUSTOMER SERVICE MANAGEMENT SYSTEM FOR DRINKING, FOOD SERVICE, HOSPITALITY, CASINO, AND OTHER RETAIL ESTABLISHMENTS

(71) Applicant: Terrence LEE, Fort Lauderdale, FL (US)

(72) Inventor: Terrence LEE, Fort Lauderdale, FL (US)

(21) Appl. No.: 18/813,997

(22) Filed: Aug. 23, 2024

(51) Int. Cl. G06V 20/40; G06Q 30/015; G06V 20/52; G06V 40/20; G09B 5/06

(52) U.S. Cl. CPC G06V 20/44; G06Q 30/015; G06V 20/52; G06V 40/20; G09B 5/065

(57) ABSTRACT

A data processing system implements obtaining, via a data interface unit, video content from a video monitoring system that captures staff and customers, the video content comprising one or more video streams captured by one or more cameras disposed throughout an establishment; analyzing the video content using a video analysis model trained to identify a customer service issue that requires attention by the staff by analyzing behaviors of the customers and the staff in the video content; generating one or more alerts to one or more members of the staff using an alert and report generation unit, each alert identifying the customer service issue; and sending, using the alert and report generation unit, the one or more alerts to one or more network-enabled computing devices of the one or more members of the staff.

### BACKGROUND

Managing personnel, operations, and inventory in drinking, food service, and retail establishments is critical to ensure the success of such establishments. Training and monitoring personnel to properly interact with and serve customers is also critical for ensuring customers have an enjoyable experience at a drinking or food service establishment. Furthermore, training and monitoring personnel to properly utilize inventory is important for avoiding waste and theft that can significantly impact revenue to the establishment. Hence, there is a need for an improved systems and methods for artificial intelligence driven inventory, personnel, and customer service management for drinking, food service, and other retail establishments.

### SUMMARY

An example data processing system according to the disclosure may include a processor and a machine-readable medium storing executable instructions. The instructions when executed cause the processor alone or in combination with other processors to perform operations including obtaining, via a data interface unit, video content from a video monitoring system that captures staff and customers, the video content comprising one or more video streams captured by one or more cameras disposed throughout an establishment; analyzing the video content using a video analysis model trained to identify a customer service issue that requires attention, the video analysis model is trained to analyze video content and identify behaviors by members of staff, customers of the establishment, or both that are indicative of a plurality of customer service issues and to output an indication of an occurrence of the customer service issue responsive to detecting behaviors indicative of the customer service issue; generating one or more alerts to one or more members of the staff using an alert and report generation unit, each alert identifying the customer service issue; and sending, using the alert and report generation unit, the one or more alerts to one or more network-enabled computing devices of the one or more members of the staff.

An example data processing system according to the disclosure may include a processor and a machine-readable medium storing executable instructions. The instructions when executed cause the processor alone or in combination with other processors to perform operations including obtaining, via a data interface unit, video content from a video monitoring system that captures staff and customers, the video content comprising one or more video streams captured by one or more cameras disposed throughout an establishment; obtaining, via the data interface unit, an indication of a location of a customer from a point-of-sale (POS) terminal; analyzing the video content using a video analysis model trained to identify a customer proximate to the location and to obtain biometric attributes information for the customer based on the video content, the biometric attributes information comprising an embeddings vector providing a numerical representation of attributes of biometric attributes of the extracted from the video content; comparing the biometric attributes information with customer data in a customer database to determine whether the customer is a returning customer; retrieving customer information from the customer database responsive to determining the customer is a returning customer; and providing the customer information to the POS terminal via the data interface unit for presentation on a user interface of the POS terminal.

An example data processing system according to the disclosure may include a processor and a machine-readable medium storing executable instructions. The instructions when executed cause the processor alone or in combination with other processors to perform operations including obtaining, via a data interface unit, video content from a video monitoring system that captures staff and customers, the video content comprising one or more video streams captured by one or more cameras disposed throughout an establishment; analyzing the video content using a video analysis model trained to identify a sanitation, security, or maintenance issue that requires attention by the staff by analyzing the video content, the video analysis model is trained to analyze video content and identify conditions in the establishment that are indicative of an occurrence of the sanitation, security, or maintenance issue based on a labeled training data that identifies a plurality of sanitation, security, and maintenance issues that can occur in the establishment; and sending, using the alert and report generation unit, the one or more alerts to one or more network-enabled computing devices of the one or more members of the staff.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

The drawing figures depict one or more implementations in accord with the present teachings, by way of example only, not by way of limitation. In the figures, like reference numerals refer to the same or similar elements. Furthermore, it should be understood that the drawings are not necessarily to scale.

FIG. 1 is a diagram showing an example computing environment in which the techniques disclosed herein for inventory and personnel management are implemented.

FIG. 2 is a diagram showing an example layout of a restaurant in which the techniques herein have been implemented.

FIGS. 3A-3E are diagrams of an example user interface for presenting alerts according to the techniques disclosed herein.

FIGS. 4A and 4B are diagrams providing examples of a user interface for providing training notifications according to the techniques herein.

FIGS. 5A and 5B are diagrams providing examples of a user interface for a point-of-sale terminal according to the techniques described herein.

FIG. 6A is an example flow chart of an example process for managing inventory and personnel according to the techniques described herein.

FIG. 6B is an example flow chart of another example process for managing inventory and personnel according to the techniques described herein.

FIG. 6C is an example flow chart of another example process for managing inventory and personnel according to the techniques described herein.

FIG. 7 is a block diagram showing an example software architecture, various portions of which may be used in conjunction with various hardware architectures herein described, which may implement any of the described features.

FIG. 8 is a block diagram showing components of an example machine configured to read instructions from a machine-readable medium and perform any of the features described herein.

### DETAILED DESCRIPTION

Techniques for artificial intelligence (AI) driven inventory and personnel management are provided herein. These techniques provide a technical solution to the technical problems associated with automatically identifying inventory and personnel management issues associated with a food service establishment, drinking establishment, casino, and/or retail establishment that can cause losses in revenue. The technical solution includes an inventory and personnel management platform that integrates with a video monitoring system and point of sale (POS) system of an establishment. The inventory and personnel management platform analyzes video content captured by one or more cameras to monitor members of staff and customers to identify various types of customer service issues in substantially real time and to generate alerts responsive to detecting these issues to one or more members of staff who can address these issues. The members of staff can include but are not limited to managers, front-of-house, and/or back-of-house members of staff. A technical benefit of this approach is that potential losses of revenue can be addressed in substantially real time to avoid further loss of revenue and/or further negative impact on the customer experience. Furthermore, the inventory and personnel management platform can also develop a remedial training plan for the members of staff based on the issues detected to help train the employee to avoid such actions in the future that result in loss of revenue for the establishment. The inventory and personnel management platform can be trained to recognize various types of customer service issues that can negatively impact the customer experience. This training can be updated over time to address additional customer service issues.

The inventory and personnel management platform also analyzes video content captured by one or more cameras to identify sanitation, security, safety, and/or maintenance issues that can impact the health and safety of customers and/or the members of the staff. These sanitation issues can include but are not limited to failure regularly empty trash receptacles, failure to adequately wash glassware and/or other serveware, failure to adequately sanitize surfaces in the bar area, and/or failure to remove dirty glasses and/or other serveware from the bar and/or customer tables within a threshold period of time. The security issues can include but are not limited to theft of property belong to the establishment and/or other customers, customers attempting to pay with counterfeit currency, and or such security issues. The safety issues can include but are not limited to customers and/or members of staff engaging in behavior that endangers themselves and/or other customers or members of staff. The maintenance issues can include but are not limited to broken or insufficient lighting, broken or damaged fixtures or furniture, broken or unavailable sanitation stations for the bartender and/or other staff to wash their hands, and/or other maintenance issues that can cause a safety hazard for the bartender, other staff, and/or customers. A technical benefit of this approach is that health and safety issues can be identified in substantially real time and an alert can be generated to alert a manager and/or other staff members to address these issues as they arise. These and other technical benefits of the techniques disclosed herein will be evident from the discussion of the example implementations that follow.

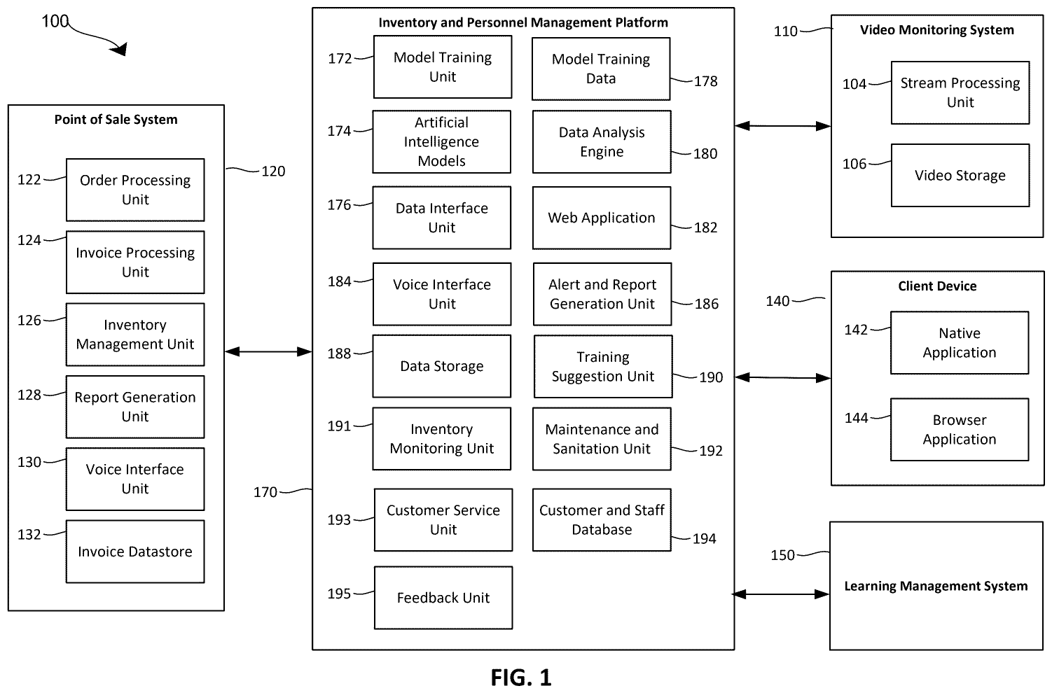

FIG. 1 is a diagram showing an example computing environment 100 in which the techniques disclosed herein for AI driven inventory and personnel management is implemented. The computing environment 100 includes an inventory and personnel management platform 170, a point of sale (POS) system 120, a video monitoring system 110, a learning management system (LMS) 150, and a client device 140. The POS system 120 communicates with the inventory and personnel management platform 170 via a network connection (not shown). The video monitoring system 110 also communicates with the inventory and personnel management platform 170 via a network connection (not shown). In the example implementation shown in FIG. 1, the inventory and personnel management platform 170 is implemented as a cloud-based service or set of services. However, in other implementations, the inventory and personnel management platform 170 can be implemented on a server of a local network or in an implementation of the POS system 120.

The video monitoring system 110 includes a stream processing unit 104 and video storage 106. The video monitoring system 110 is configured to receive video streams captured by cameras disposed throughout a restaurant, drinking establishment, or retail establishment. The video cameras can be placed such that one or more cameras are enabled to capture at least one view of areas in which the staff operating the establishment and/or customers of the establishment are present. Certain areas may be excluded from the camera coverage due to privacy reasons, such as but not limited to restroom facilities, locker rooms, or changing rooms, or other such areas that depend on the type of establishment. The video monitoring system 110 can be connected with the video cameras via wired and/or wireless connections. The video cameras also have a sufficient resolution that the inventory and personnel management platform 170 can analyze video streams captured by these cameras to identify staff members and customers in the video content as well as identify various customer service, sanitation, security, or maintenance issues. The stream processing unit 104 is configured to receive the video streams from the video cameras and to store the video streams in the video storage 106 and/or send received video streams to the inventory and personnel management platform 170 for analysis. All of the video streams can be stored in the video storage 106 or another storage device for reference purposes. The stored video streams can be used for security purposes to serve as a record of incidents occurring in an establishment and/or used to monitor employee work performance related to legitimate business interest of the establishment. The video monitoring system 110 can be implemented as a computing system implemented locally at the restaurant, drinking establishment, or retail establishment or located remotely. Some implementations of the video monitoring system 110 are a cloud-based service or set of services that stores and/processes video streams received from video cameras over a network connection.

The POS system 120 includes an order processing unit 122, an invoice processing unit 124, an inventory management unit 126, a report generation unit 128, a voice interface unit 13, and invoice datastore 132. The order processing unit 122 provides a user interface that enables a bartender, waitstaff member, or other members of the staff of the establishment to enter orders for drinks, food, and/or retail items. The order processing unit 122 forwards drink orders to a POS terminal at the bar for drinks that are to be made by the bartender and food orders to a terminal or terminals at the kitchen. The bartender or kitchen staff can then create the ordered items. The invoice processing unit 124 can be used to generate a bill or invoice for the customers that itemizes the items that the customers have ordered and any associated taxes or fees that the customer may owe. The invoice processing unit 124 stores invoice information in the invoice datastore 132, which is a persistent datastore in the memory of the POS system 120. The invoice processing unit 124 can generate physical copies of the invoice to present to customers and/or present an electronic copy of the receipt to the user on a portable POS terminal. The portable POS terminal can also process electronic payments and/or send electronic copies of the invoice and/or payment information. The POS terminals, whether stationary or portable, can also present customer information on a user interface of the terminal to provide the member of staff serving the customer with information about the customer, such as but not limited to customer preference information that indicates the items that the customer typically orders, preferred seating locations, and/or other information indicative of the preferences of the customer. Additional details of the customer information and customer preference information are discussed in the examples which follow.

The inventory management unit 126 of the POS system 120 tracks the inventory of ingredients for food and drinks that may be ordered. The POS system 120 can prevent orders from being entered for drinks or food items which require ingredients that have been depleted. The inventory management unit 126 provides a user interface that enables a manager to order items from suppliers. The inventory management unit 126 enables the manager to set up or modify standing orders with suppliers requesting that the supplier regularly deliver specific products to ensure that the establishment has sufficient supply of inventory items.

The report generation unit 128 generates various types of reports from data associated with the POS system 120. These reports can include but are not limited to sales reports identifying drinks and/or food items sold. These reports can also include inventory reports that provide an indication of the inventory items available, the projected rate at which these inventory items are likely to be depleted based on sales projections, costs associated with purchasing additional inventory, and/or other inventory related information. The report generation unit 128 provides a set of report templates for generating reports typically used by drinking and/or food service establishments. The report generation unit 128 can also include a user interface that enables managers to create custom reports from the sales and/or inventory information.

The voice interface unit 130 provides a voice interface that enables users to provide voice commands to the POS system 120 via a stationary or portable POS terminal.

The voice interface unit 130 can receive voice commands captured by the device and analyze these commands using a voice-to-text language model. The voice-to-text language model converts the voice input to text, and the voice interface unit 130 analyzes the text to determine whether the user has issued any commands to be performed by the POS system 120. For instance, the user may speak an order to the POS terminal and/or modify an existing order by speaking to the POS terminal. The voice interface unit 130 can be configured to support other types of commands as well. A technical benefit of this approach is that it provides a hands-free means for entering orders in which a member of the waitstaff can speak an order without having to navigate a complex user interface.

The inventory and personnel management platform 170 includes a model training unit 172, model training data 178, artificial intelligence (AI) models 174, data analysis engine 180, data interface unit 176, web application 182, voice interface unit 184, alert and report generation unit 186, data storage 188, training suggestion unit 190, inventory monitoring unit 191, maintenance and sanitation unit 192, customer service unit 193, a customer and staff database 194, and a feedback unit 195.

The inventory and personnel management platform 170 utilizes one or more AI models 174. These models can include a video analysis model trained to analyze video streams captured by the video monitoring system 110. The video analysis model is trained to analyze the video streams to monitor the performance of the members of staff and customer behavior to identify customer services issues and/or staffing issues. The customer service issues can include but are not limited to determining that a customer appears to be looking for a member of the staff to place an order or make a request (such as to order food or pay their bill); determining that a customer has finished their food, drink, or both food and drink, determining that plates, drinkware, or both plates and drinkware have not been cleared for more than a threshold period, determining that food ordered by a customer has been prepared by a kitchen and ready to be picked up and served to the customer for more than a threshold period of time, and/or determining that there are discrepancies between the food, drinks, and/or other items ordered by the customer and the food, drinks, and/or items actually served to the customers. The customer service issues can also include time it takes for a member of staff and/or a manager to greet customers, how long it takes for a customer to be seated, how long it takes for a menu to be delivered to the customer, and/or how long it takes for an initial drink order to be taken. The staffing issues can include staff members arriving late, leaving early, not clocking in or out on time, hanging around at the venue after clocking out, failure to complete or efficiently complete opening and/or closing tasks, and/or such staffing issues. The staffing issues can also include staff members performing their duties at a much slower pace or inefficiently compared to other members of staff. The video analysis model can be trained to identify situations in which such performance issues occur so that additional training and/or other actions may be taken by the management. As discussed in the examples which follow, the video capturing such issues can be provided to managers and/or included with training recommendations to demonstrate why the video analysis model indicated that an issue occurred.

The video analysis model is also trained to analyze the video streams to identify sanitation, security, safety, or maintenance issues. The sanitation issues can include but are not limited to failure regularly empty trash receptacles, failure to adequately wash glassware and/or other serveware, failure to adequately sanitize food or drink preparation surfaces, failure to remove dirty glasses and/or other serveware from the bar and/or customer tables within a threshold period of time, and/or other issues that present an unsanitary condition that can pose a health hazard to staff and/or customers of the establishment. The maintenance issues can include but are not limited to broken or insufficient lighting, broken or damaged fixtures or furniture, damaged carpeting and/or other flooring, broken simulators for venues offering such simulators as entertainment options to customers, broken or unavailable sanitation stations for the bartender and/or other staff to wash their hands, and/or other maintenance issues that can cause a safety hazard for the bartender, other staff, and/or customers. The inventory and personnel management platform 170 can keep track of how long a particular maintenance issue has been occurring and any actions that have been taken to mitigate the issue. These issues can be included in alerts and/or reports related to these maintenance issues. The security issues can include but are not limited to the unauthorized removal of property belonging to the establishment by a member of the staff or a customer. The safety issues can include recognizing spills, incorrect storage of chemicals, knives, and/or other items that can potentially cause injury, recognizing water leaks, and/or other hazards that could cause injury to the staff or customers. The safety issues can also include recognizing behavior by customers and/or members of staff that can potentially result in injury to the customers or member of staffs and/or other customers and/or members of staff. For example, some establishments can include simulators, games, and/or other types of entertainment options that customers may participate in. While these entertainment options have been vetted to be safe, customers may engage in horseplay or other behavior that is outside of the intended usage of these entertainment options. Recognizing and alerting the appropriate members of staff to such safety issues can avoid expensive workers compensation cases and/or compensation to customers for injuries. The video analysis model can be trained to identify additional types of customer service, sanitation, security, safety, staffing and/or maintenance issues. Furthermore, the customer service, sanitation, security, safety, staffing and/or maintenance issues identified in a particular venue can be used to generate design recommendations for future venues can be analyzed by the inventory and personnel management platform 170 to generate recommendations for the design of future venues to prevent or mitigate such issues. The video analysis model can be trained to recognize other types of customer service, sanitation, security, safety, staffing and/or maintenance issues not included in the examples discussed above.

In some implementations, the video analysis model is a multimodal model that is trained to receive video streams and invoice information as an input and to identify discrepancies between the items served to the customers and the items that were actually ordered by the customers. The invoice information includes food, drinks, and/or other items that have been input by the staff into the POS system 120. The video analysis model outputs incident information when such discrepancies are detected. The incident information can include information identifying what was ordered and what was actually served to the customers. The video analysis model can analyze the invoice information and the video stream content to determine how much time has elapsed between the order for an item being entered into the POS system 120 and the item being prepared by the staff of the establishment and whether this discrepancy exceeds a fulfillment threshold. The video analysis model can also analyze the invoice information and the video content to determine whether food and/or drinks have been prepared with the proper presentation, including but not limited to the correct glassware or serveware, correct garnishes, and/or other attributes of the presentation. The video analysis model can also recognize whether the right ingredients have been added to drinks by the bartenders. As discussed in detail in the examples which follow, this discrepancy information can be used to generate alerts and/or reports in substantially real time as the bartender is operating the bar.

The model training unit 172 utilizes the model training data 178 to train the video analysis model and/or other models of the AI models 174. For recognizing whether drinks have been created correctly, the model training data 178 includes labeled data used to train the video analysis model to recognize bottles of spirits and/or other bottled ingredients so that the model can determine which ingredients the bartender included in drinks being prepared. The training data can include views of the bottles from multiple angles and/or partially obscured to enable the model to analyze video streams of the bartender preparing drinks and determine which spirits or other ingredients the bartender used in preparing the drinks. The training data may include labeled images and/or videos that feature the spirits and/or other items that the model is supposed to be trained to recognize. The training data can also include the labeled images of the drink being presented on one or more preferred glassware options. The training data can also include examples of the drinks with the correct garnishes added. For training the video analysis model to recognize whether food items have been created and/or presented correctly, the training data can include examples of the food items that have been prepared in one or more acceptable ways and one or more acceptable presentations for those food items. The model training data 178 can also include validation data, which is another set of labeled data that is used by the model training unit 172 to determine whether the trained video analysis model is correctly predicting whether there are any discrepancies. Training data can also be added for recognizing when there are customer service, sanitation, security, or maintenance issues. The training data can include examples that help the model learn to identify when such issues arise. Additional training data can be added to the model training data 178 as new items are added to the inventory and/or the label or bottle of an item is modified by the manufacturer, when new food or drink items are introduced or updated on the menu, when fixtures and/or other elements of the establishment are updated, and/or when customer service protocols are updated.

The feedback unit 195 provides a means for users to provide feedback on the alerts, reports, and/or training recommendations generated by the AI models 174. The native application 114 and/or the web application 182 provide a feedback user interface in some implementations in which an authorized user, such as but not limited to a manager, can select alert, report, and/or training recommendations that have been generated by the AI models 174 and provide feedback indicative of errors in the alert, report, and/or training recommendations. The user can provide feedback that a customer service, sanitation, safety, security, and/or a maintenance issue has been incorrectly identified. The feedback user interface can also enable the user to provide feedback that a customer or staff member has been incorrectly identified either in an alert, report, or training recommendation or in the information provided to the POS system 120. The user can provide an indication that the system incorrectly identified a customer or staff member and can provide a correct identity for the incorrectly identified customer or staff member. The feedback unit 195 also provides means for users to provide feedback for calibrating which issues should be reported in real-time and which issues can be reported in a report that can be handled at later time. The feedback unit 195 can provide a user interface that enables an authorized user to select alerts and/or reports that have been generated by the system and to provide feedback indicating whether the issues included thereon should have been reported in real time or in a summary report for handling later. This feedback can be used by the feedback unit 195 to fine tune the training of the AI models 174 correctly handle generating of alerts, reports, and/or training request for specific issues in real time or for handling later.

The user interface enables the user to input feedback that describes the error that occurred. The user interface also enables the user to view imagery and/or video content associated with the alert, report, or training request or the misidentification of the customer or member of staff. In some implementations, the user interface of the feedback unit 195 can present a set of predetermined questions that help guide the user to input information regarding the incorrect identification that can be provided to the model training unit 172 to generate training data that correctly labels the imagery and/or videos that was misclassified by the video analysis model and/or other models of the AI models 174. The new training data is stored in the model training data 178 and is used by the model training unit 172 to fine-tune the training of the model or models that misclassified the imagery and/or video content.

The AI models 174 can include additional models, such as a generative language model that is configured to generate alerts, reports, and/or training recommendations based on the customer service, sanitation, security, or maintenance issues identified by the video analysis model as discussed above. The generative language model can include but is not limited to a Generative Pre-trained Transformer model, such as GPT-4 or GPT-4o. Other such generative language models can also be utilized by the inventory and personnel management platform 170. The generative language models may be implemented on the inventory and personnel management platform 170 or implemented by a remote server that is accessible over a network connection. In such implementations, the data analysis engine 180 is configured to construct a prompt to the generative language model to cause the generative language model to generate the text of the alerts, reports, and/or training recommendations based on the customer service, sanitation, security, or maintenance issues identified by the video analysis model. The data analysis engine 180 can construct the prompts using prompt templates to ensure that the instructions to the generative model are consistent.

The data interface unit 176 provides received information from the POS system 120 and/or the video monitoring system 110 and formats this data to consistent predetermined formats utilized by the inventory and personnel management platform 170. A technical benefit of this approach is that the inventory and personnel management platform 170 can interact with various types of POS systems and/or video monitoring systems without requiring that the POS systems and/or the video monitoring systems be customized for use with the inventory and personnel management platform 170. For example, the data interface unit 176 can format invoice information received from the POS system 120 and/or video streams received from the video monitoring system 110. The data interface unit 176 can store the standardized data in the data storage 188, which is a persistent datastore in the memory of the inventory and personnel management platform 170. The data interface unit 176 can also provide the standardized data to the data analysis engine 180 for processing. The data interface unit 176 can also provide customer information the POS system 120 to be presented on a user interface of a POS terminal as discussed in the examples which follow.

The data analysis engine 180 analyzes invoice information for orders entered in the POS system 120 and one or more video streams of the bartender preparing drinks captured by cameras associated with the video monitoring system 110 to identify various types of customer service, sanitation, security, or maintenance issues. The data analysis engine 180 provides video streams of the content captured by the cameras of the video monitoring system 110 to the video analysis module (not shown) of the AI models 174 for analysis. The data analysis engine 180 can provide each of these video streams to the video analysis model. Some implementations of the video analysis model are capable of receiving and analyzing multiple video content streams simultaneously, while other implementations analyze the video content streams separately. In implementations where multiple streams are analyzed separately, the data analysis engine 180 can correlate the predictions output by the video analysis model when analyzing the individual streams to determine whether there were any customer service, sanitation, security, or maintenance issues. A technical benefit of this approach is that when the view from a camera is partially obscured, making it difficult to determine whether there were any issues, the view of another camera is able to more clearly capture the members of staff, customers, and/or fixtures or other elements of the establishment. Data from multiple video streams can be corelated to provide a more accurate analysis. Furthermore, the video analysis module can be a multimodal model and the data analysis engine 180 can provide invoice information to the video analysis model as one of the inputs to enable the video analysis model to identify discrepancies between the items ordered and items served to a customer.

The data analysis engine 180 provides information identifying customer service, sanitation, security, or maintenance issues generated by the video analysis model and/or generated by the data analysis engine 180 by correlating data from multiple video streams to the alert and report generation unit 186 and/or the training suggestion unit 190. The data analysis engine 180 processes the invoice information and/or the video content streams in substantially real time, and thus, provides the substantially real time information regarding issues to the alert and report generation unit 186 and/or the training suggestion unit 190. Consequently, the inventory and personnel management platform 170 can monitor these sanitation, security, safety and/or maintenance issues in substantially real time and generate reports and/or alerts for a manager or other members of the staff so that action can be taken quickly to reduce the likelihood of substantial loss of revenue and/or negatively impacting the experience of customers.

The alert and report generation unit 186 analyzes the sanitation, security, or maintenance issues identified by the video analysis model and generates alerts to a manager or other appropriate staff member when such issues arise. The alert and report generation unit 186 determines which members of staff should receive the alerts and/or reports based on the type and severity of the alert being generated. In some implementations, the alert and report generation unit 186 provides a user interface that enables authorized users to determine which members of staff should be alerted, receive reports, and/or training recommendations.

These alerts and/or reports can be generated in substantially real time as issues are detected by the inventory and personnel management platform 170. The alerts can include text messages, emails, or other types of messages to a manager that can be received on a mobile phone, tablet, a portable POS terminal, or other types of mobile computing device that can be carried or worn by the manager on duty and/or other members of the staff. The alerts notify the manager and/or the other staff members of issues that could negatively impact customer satisfaction and/or the establishment's revenue. The manager and/or other staff members can follow up on these issues as they are occurring or shortly thereafter to ensure that issues do not continue to impact the operations of the establishment. Alerts typically include single issues that are identified by the inventory and personnel management platform 170, while reports may include a summary of multiple issues and/or provide additional details related to alerts that have been generated. The inventory and personnel management platform 170 stores the alerts in the data storage 188 and provides a user interface for the managers to view alerts and or reports that have been created by the alert and report generation unit 186.

The training suggestion unit 190 analyzes the customer service, sanitation, security, or maintenance issues and suggests training content to present to members of the staff that may help improve their performance. The training suggestions can related to all areas of service or hospitality. The training content is managed by the LMS 150 in some implementations. The training content can include various types of training, such as but not limited to customer service, streamlining processes to help improve drink fulfillment times, avoiding waste, and the impact on the budget of the establishment caused by providing non-revenue drinks to customers. The training content can also address various types of customer service, sanitation, security, or maintenance issues and how staff can avoid and/or quickly mitigate such issues. The training content can be developed for various topics, labeled, and stored on the inventory and personnel management platform 170. Some implementations rely on external training content sources, such as the LMS 150, and provide a link to the external content. The training suggestion unit 190 and/or the LMS 150 can also generate a performance improvement plan for the members of the staff that is shared with the members of the staff and/or their manager. For instance, the training suggestion unit 190 can be configured to recommend training for members of staff that perform more than a threshold number of errors when performing a specific task and/or repeatedly have errors when performing that task more than a threshold number of times. The performance improvement plan can include various milestones to be achieved to improve the performance of the members of the staff. The training suggestion unit 190 and/or the LMS 150 can track these milestones and notify the manager as these milestones are completed. For instance, these milestones can include completion of specific training tasks and/or performing certain actions. The training suggestion unit 190 and/or the LMS 150 can also generate daily, weekly, monthly, and/or annual summaries of the training recommendations that have been made to members of staff and provide these summaries of to the members of staff and/or their respective managers. The training summary can include information indicating the recommended training that has been completed and the training that has yet to be completed.

The voice interface unit 184 provides a voice interface that enables users to provide voice commands to the inventory and personnel management platform 170 via a portable POS terminal or client device 140. The voice interface unit 184 can receive voice commands captured by the device and analyze these commands using a voice-to-text language model implemented by the AI models 174. The voice-to-text language model converts the voice input to text, and the voice interface unit 184 analyzes the text to determine whether the user has issued any commands to be performed by the inventory and personnel management platform 170. For instance, the user may enter a spoken command to view details of an alert. The voice interface unit 184 can be configured to support other types of commands as well. The POS system 120 also includes a touchscreen, keypad, and/or other type of tactile interface that enables bartenders and/or other staff members to enter orders for drinks, food, and/or other items, check the status of the orders, and/or to facilitate payment of the invoices associated with these orders.

The inventory monitoring unit 191 outputs supply information identifying the ingredients and/or other supplies utilized in preparing drinks and/or food item and/or retail items sold to customers. The supply information is not limited by the recipe information and/or invoice information obtained from the POS system 120. Instead, the supply information indicates the actual inventory items that were utilized by the bartender, the kitchen, and/or other members of the staff. These supplies can include alcoholic and/or non-alcoholic drinks, garnishes used on drinks, stir sticks and/or straws, napkins, drink mats, and/or other inventory items that are used to prepare and/or serve drinks. The supplies can also include premade food items and/or ingredients used to prepare food items that were prepared by the kitchen staff. The supplies can also include drinkware and/or other serving ware that is detected as being discarded due to breakage by either the bartender, other staff members, or by customers. The supply information can also include other retail items that are sold by the establishment, such as but not limited to souvenir items and/or other products that are sold by the establishment. Tracking the usage of the various types of inventory items using the inventory and personnel management platform 170 provides a more accurate assessment of the inventory items that are likely to be required rather than having a human manager estimate the needs. Consequently, the budgeting and spending for inventory can be more accurately predicted and the items that are likely to be required are more likely to be in stock to meet customer demand.

The inventory monitoring unit 191 utilizes one or more video analysis models to analyze the video streams obtained from the video monitoring system 110. These video analysis models can be the same models as those discussed above or can be video analysis models trained to recognize inventory items and/or the utilization thereof by the bartender, other staff, and/or customers. The one or more video analysis models identify inventory items that have been utilized. The inventory monitoring unit 191 interfaces with the inventory management unit 126 of the POS system 120 via the data interface unit 176 to notify the inventory management unit 126 of the inventory items that have been utilized. The inventory management unit 126 can then facilitate reordering of these items as necessary. While the inventory management is performed at least in part by the POS system 120 shown in the example implement of FIG. 1, other implementations of the inventory and personnel management platform 170 can implement the inventory management functionality of the inventory management unit 126.

The maintenance and sanitation unit 192 utilizes one or more video analysis models to analyze the video streams obtained from the video monitoring system 110 to automatically identify and react to maintenance and/or sanitation issues in the establishment that can negatively impact the customer experience and/or result in health code violations that could lead to illness and/or sanctions by regulatory bodies tasked with ensuring that the bar, restaurant, and/or retail establishment is being operated according to local sanitary requirements. These models can be the same video analysis models as those discussed in the preceding examples or can be specifically trained to recognize maintenance and/or sanitation issues. In a non-limiting example, the maintenance and sanitation unit 192 can identify sanitation issues, such as but not limited to maintaining a cluttered work area, failure to regularly empty trash receptacles, failure to adequately wash glassware and/or other serveware, failure to adequately sanitize surfaces in the bar area, and/or failure to remove dirty glasses and/or other serveware from the bar and/or customer tables within a threshold period of time. In another non-limiting example, the maintenance and sanitation unit 192 can identify maintenance issues, such as but not limited to broken or insufficient lighting, broken or damaged fixtures or furniture, broken or unavailable sanitation stations for the bartender and/or other staff to wash their hands, and/or other maintenance issues that can cause a safety hazard for the bartender, other staff, and/or customers. The video analysis model outputs an indication of the maintenance and/or sanitation issues detected in the video content and provides this indication to the alert and report generation unit 186 to cause the alert and report generation unit 186 to generate alerts and/or reports in response to detecting the maintenance and/or sanitation issues.

The customer service unit 193 utilizes one or more video analysis models to analyze the video streams obtained from the video monitoring system 110 to automatically identify and react to customer service issues that can negatively impact the customer experience. These models can be the same video analysis models as those discussed in the preceding examples or can be specifically trained to recognize customer service issues. The video analysis model is trained to identify various types of customer service events. The video analysis model outputs an indication of the type of customer service issue detected in the video content and provides this indication to the alert and report generation unit 186 to cause the alert and report generation unit 186 to generate alert and/or report in response to detecting the customer service issues. Some non-limiting examples of customer service issues include but are not limited to determining that a customer appears to be looking for a member of the staff to place an order or make a request (such as to order food or pay their bill); determining that a customer has finished their food, drink, or both food and drink, determining that plates, drinkware, or both plates and drinkware have not been cleared for more than a threshold period, determining that food ordered by a customer has been prepared by a kitchen and is ready to be picked up and served to the customer for more than a threshold period of time, and/or determining that there are discrepancies between the food, drinks, and/or other items ordered by the customer and the food, drinks, and/or items actually served to the customers. The customer services issues can also monitor bar occupancy including bar seating, table seating, and/or standing customers. Other types of customer service issues can also be supported by the video analysis model by creating model training data to train the model to recognize these customer service issues. The customer service 193 can also be trained to recognize other type of customer service issues related to entertainment provided in establishment where such features are provided. For instance, the customer service unit 193 can determine whether a band, disc jockey, dancer, and/other entertainers are performing during the periods of time that they are scheduled to perform and that they are performing what they were supposed to be performing. The customer service unit 193 can also be trained to identify other issues related to audio and/or video content being presented in the establishment. For instance, the volume and/or type of music being played in the venue is appropriate for that type of establishment. In another non-limiting example, the customer service unit 193 can determine that the telecast of a game that was being presented in a sports bar or similar venue has completed and non-sports related content is now being presented and a member of staff should be alerted to change the content to something else more appropriate for the venue.

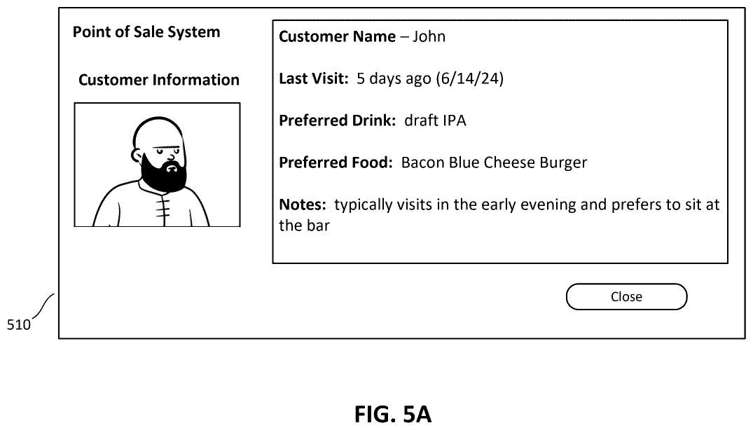

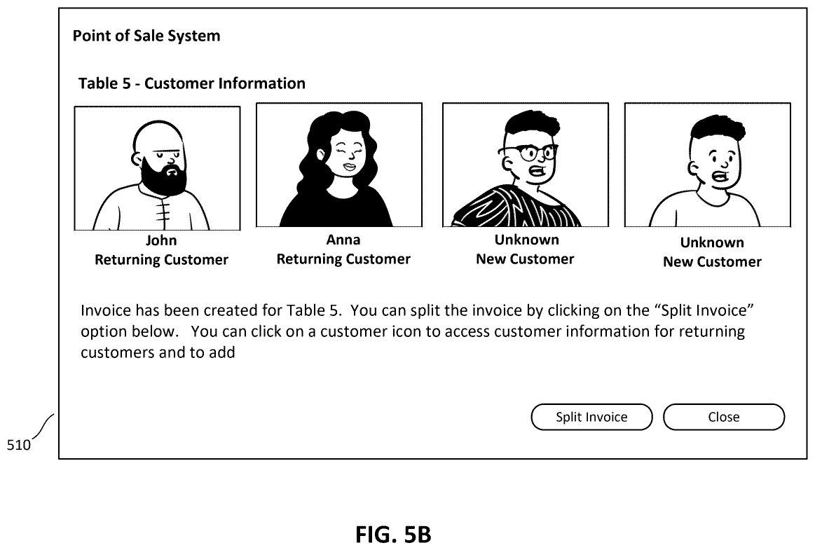

The customer service unit 193 also supports recognition of members of the staff and/or customers in the video content obtained from the video monitoring system 110. The customer and staff database 194, discussed in greater detail below, stores information associated with the staff members and/or customers that the customer service unit 193 uses to determine whether a person detected in the video content captured by the video monitoring system 110 is a staff member or a returning customer. In some implementations, the video analysis model generates biometric attributes information for a person identified in the video. These biometric attributes can be based on physical characteristics of the user, such as but not limited to facial features for facial recognition, body shape and/or size, voice attributes for voice recognition, and/or other attributes of the person that can be used to identify the person as a member of staff, a new customer, or a returning customer. In some implementations, the biometric attributes are represented by embeddings comprising a vector of numerical values that represent the biometric attributes of the person. The customer information stored in the customer and staff database 194 is associated with the embeddings that were determined at the time that the customer information or staff was added to the customer and staff database 194 and/or updated. For customers, the customer service unit 193 can provide the customer information to a POS terminal for presentation on a user interface of the terminal as discussed with respect to FIGS. 5A and 5B in the examples which follow.

The customer and staff database 194 is a persistent datastore in the memory of the inventory and personnel management platform 170. The customer database 194 stores customer information for customers of the establishment as well as members of the staff. As discussed above, the customer service unit 193 creates and populates a customer service information data structure for customers that are detected in the establishment by analyzing the video content obtained from the video monitoring system 110. The customer information includes a timestamp indicating when the customer information data structure was created. The customer information includes one or more images of the customer that have been extracted from the video streams by the customer service unit 193. The customer service information also includes customer preference information and/or spending habit information that indicates items that the customer has ordered in the past and entertainment options that the user has purchased in the past for venues offering such options. This information can be used to provide a personalized experience for the customer and increase customer engagement, because the staff can suggest items that the customer has ordered in the past and/or make recommendations for other items that the customer may wish to order in future visits to the establishment. The customer information also includes biometric information in some implementations that is used by the customer service unit 193 to match customers detected in the video content obtained from the video monitoring system 110 with customers in the customer database 194 so that returning or repeat customers can be identified. The customer information can be used to support a customer loyalty program and/or to support targeted marketing to send customer promotions via email, text, and/or other postal mail that are likely to entice the customer into returning to the establishment. In some implementations, the loyalty program provides real-time discounts and/or incentives that are provided to the customer during their visit. The system can also provide other type of incentives, such as but not limited to cross-promotions with credit card companies and/or other types of vendors. For instance, the video analysis model and/or the POS system 120 can recognize that the customer has a credit card issue by particular bank that has partnered with the establishment to offer certain discounts and/or incentives to their customers. Other such partnerships are also possible with spirit manufacturers and/or other vendors who supply products and/or services that are utilized by the customers of the establishment. These incentives can be presented on a POS terminal to members of staff who can offer these discounts and/or incentives to the customer when ordering. In other instances, the system can send a text message, email, or other type of message to the user when they enter the establishment and/or are seated offering the discounts and/or other incentives. The message can include a QR code that can be scanned by a member of staff to provide the discount and/or incentive. In some implementations, the message notifies the customer of the discount and/or incentive, and the discount and/or incentive is automatically applied to the customer invoice. The customer information can also include demographic information for the user, such at but not limited to age, sex, city and/or state or residence, and/or other information that may be relevant to offers and/or incentives that may be provided to the customer. For instance, a sports bar or similar venue may offer discounts and/or incentives for customers residing in a specific location when the venue is going to be televising games from sports teams associated with that location.

With respect to the staff members, the customer and staff member database includes information about the staff member, such as but not limited to one or more images of the staff member, the role or roles of the staff member in the establishment, schedule information indicating when the staff member is scheduled to be working, and/or other information associated with the staff member. The staff information also includes biometric information, in some implementations, that is used by the customer service unit 193 and/or other components of the inventory and personnel management platform 170 to match staff members detected in the video content obtained from the video monitoring system 110 with staff members in the customer and staff database 194 so that members of staff can be identified.

The client device 140 is a computing device that can be used to view reports and/or alerts generated by the inventory and personnel management platform 170. The client device 140 can be used by a manager of a drinking or food service establishment to view the alerts generated by the inventory and personnel management platform 170. The client device 140 may alternatively be used by a member of staff to view alerts and/or reports generated by the inventory and personnel management platform 170. The client device 140 can also be used by the member of staff to view and/or participate in training suggested by the inventory and personnel management platform 170. The client device 140 can also serve as a portable POS terminal in some implementations.

The client device 140 can be implemented as a portable electronic device, such as a mobile phone, a tablet computer, a laptop computer, a portable digital assistant device, and/or other such devices. The client device 140 may also be implemented in computing devices having other form factors, such as a desktop computer and/or other types of computing devices. In some implementations, the functionality of the client device 140 is implemented by the POS system 120. While the example implementation shown in FIG. 1 includes just one client device, other implementations may include a different number of client devices that utilize the inventory and personnel management platform 170.

The client device 140 includes a native application 142 and a browser application 144 in the example implementation shown in FIG. 1. Other implementations may include one or other of these applications. The browser application 144 is an application for accessing and viewing web-based content, the web-based content may be provided by the inventory and personnel management platform 170. The inventory and personnel management platform 170 provides the web application 182 that enables users to view alerts, reports, and/or training content in some implementations. A user of the client device 140 may access the web application 182 via the browser application 144, and the browser application 144 renders a user interface for interacting with the inventory and personnel management platform 170 in the browser application 144. The native application 142 is a web-enabled application that is capable of rendering content such as alerts, reports, video content, and/or training content obtained from inventory and personnel management platform 170.

The LMS 150 is a platform for creating, managing, and delivering training content. The LMS 150 can store various types of training course content that can be consumed online. The training course content can include video content, slide presentations, and/or textual content that can be used to train members of staff. The LMS 150 generates training plans for members of staff based on performance issues identified by inventory and personnel management platform 170, tracks the completion of the recommended training included in the training plan, and/or tracks whether the performance issues that triggered the training suggestion unit 190 and/or the LMS 150 to recommend the training plan have been remedied or further training may be required. The LMS 150 provides a web-based interface that that members of staff can utilize to access and complete the training recommended in their respective training plans. The LMS 150 also provides a user interface for managers, owners, and/or other authorized users to design training plans for responding to the types of performance issues that can be identified by the training suggestion unit 190. The training plans may include content that has been provided by the LMS 150 and/or establishment-specific content that has been generated by or for the establishment and is maintained on the LMS 150. The training plan recommendations can be updated periodically in response to the training suggestion unit 190 being updated to identify additional types of performance issues that can occur at the establishment.

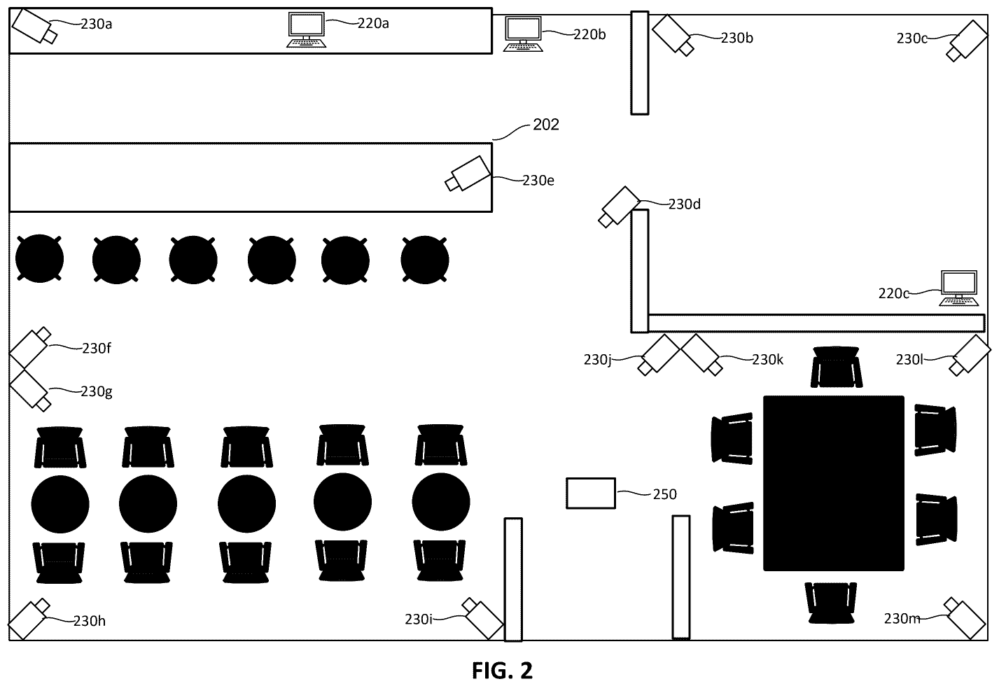

FIG. 2 is a diagram showing a non-limiting example layout of a restaurant in which the techniques herein have been implemented. The restaurant includes a bar 202 with bar stools that provide seating at the bar. The restaurant also has tables and chairs for customers disposed throughout the restaurant. The cameras 230a-230m are disposed throughout the restaurant and provide video streams of their respective fields of view to the video monitoring system 110. The POS terminals 220a and 220b enable the bartenders and/or other staff to enter orders for food, drinks, and/or other items. The POS terminal 220c is disposed in the kitchen and enables the kitchen staff to view and prepare food orders. The host station 250 can also include a POS terminal (not shown) that enables a host or hostess to view available seating, to access and/or make reservations, and/or add walk-in customers to a wait list.

The cameras 230a, 230e, and 230f have views of the bar, dining, kitchen and/or other in the establishment. The video streams from these cameras can be analyzed by the inventory and personnel management platform 170 to monitor the bartender or waitstaff placing orders for food and/or drinks and the bartender making drinks. As discussed in the preceding examples, the inventory and personnel management platform 170 analyzes these video streams to identify customer service, sanitation, security, and/or maintenance issues. The inventory and personnel management platform 170 can identify these issues as they are occurring or shortly thereafter and alert a manager so that action can be taken rapidly to prevent further losses. As discussed above, the inventory and personnel management platform 170 can also make training recommendations for addressing problematic behavior and improving performance of staff members. Furthermore, the inventory and personnel management platform 170 can also be used to highlight members of staff who are performing well so that the management can reward these valuable members of the staff. Using the inventory and personnel management platform 170 to determine employee performance provides an objective measurement of employee performance. The inventory and personnel management platform 170 also analyzes the video streams to identify return or repeat customers so that the customer information can be accessed and presented on the POS terminal. A technical benefit of this approach is that the inventory and personnel management platform 170 automatically identifies returning customers and presents information associated with the customers to the waitstaff, bartender, or other members of staff so that the customer preferences can be utilized when serving the customer.

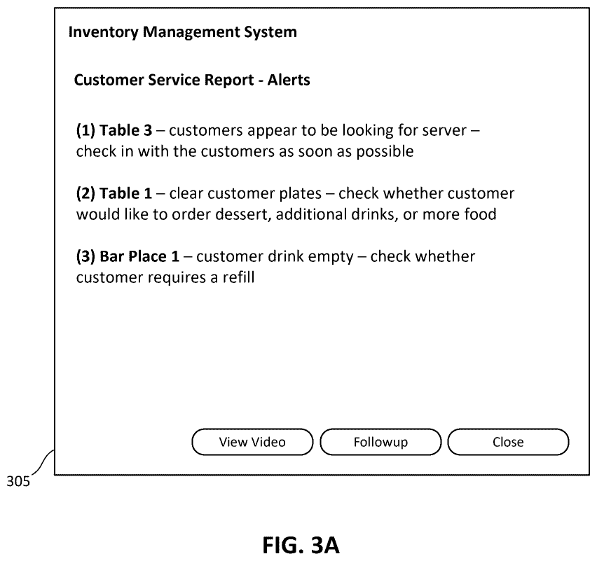

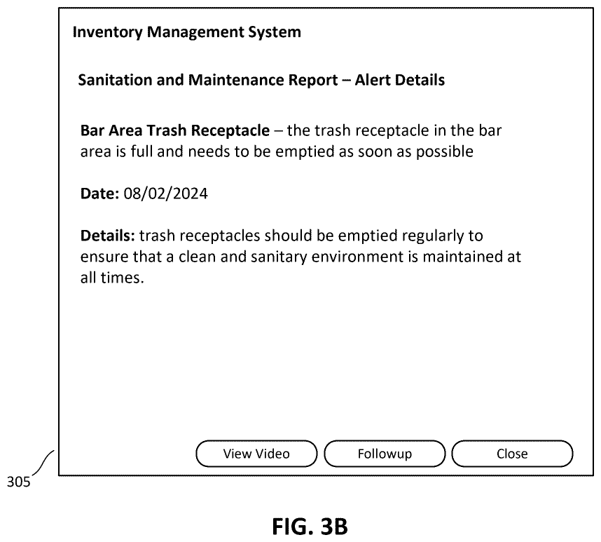

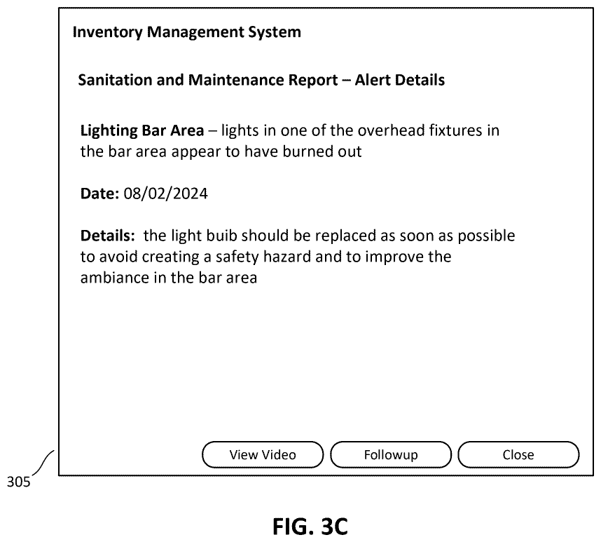

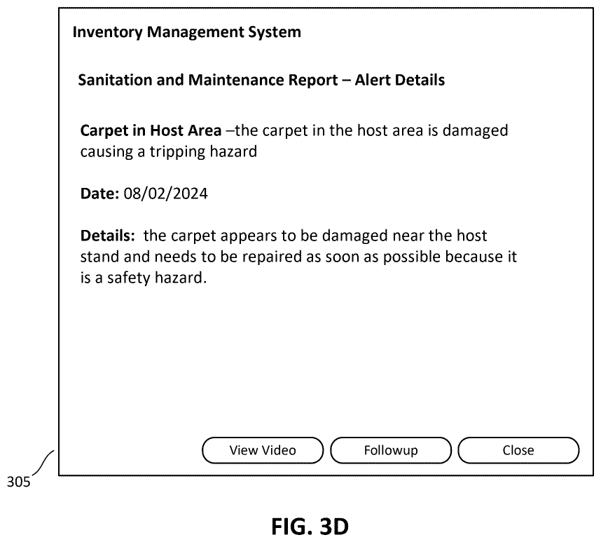

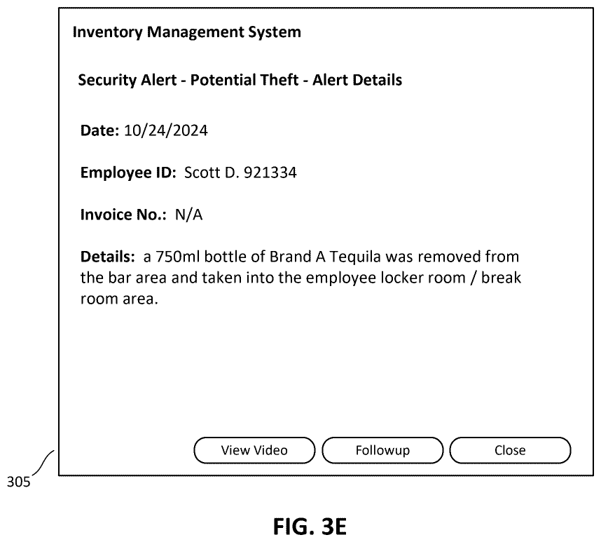

FIGS. 3A-3E are diagrams of an example user interface 305 for presenting alerts according to the techniques disclosed herein. The user interface 305 can be implemented by an alerts and reporting application implemented by the native application 142 on a client device 140 or on a POS terminal associated with the POS system 120. The alerts are generated by the alert and report generation unit 186 of the inventory and personnel management platform 170. FIG. 3A shows an example of customer service issue alerts presented on the user interface 305. In this example, multiple customer service issue alerts have been issued, and the user interface 305 provides a list of the issued alerts. A user can click on or otherwise select one of the entries in the list to cause the user interface 305 to present details of the selected alert. The specific alerts presented on the user interface 305 are user specific. The alert and report generation unit 186 generates alerts for specific members of staff and/or managers that can address the issues indicated in the alert. FIGS. 3B, 3C, and 3D show examples of sanitation and maintenance issue alerts. In these examples, a single alert has been issued, and the user interface 305 presents the details of the alert rather than the list interface shown in FIG. 3A. The details of the alert provide information indicating what issue has occurred and how the issue can be remedied. FIG. 3E shows an example of a security alert that indicates a possible theft. The user interface 305 includes controls that when clicked on or otherwise actuated, enable the user to close the alert, to create a reminder to follow up on the alert, or to access imagery or video associated with the alert. The imagery and/or video can help a recipient of the alert more quickly understand what triggered the alert.

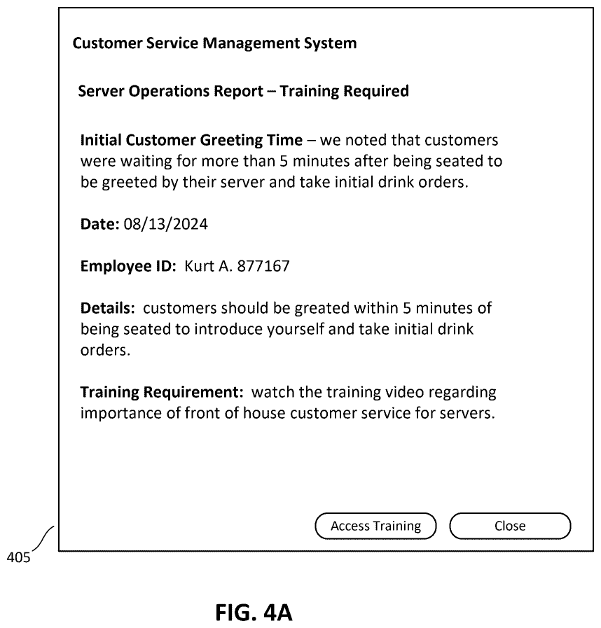

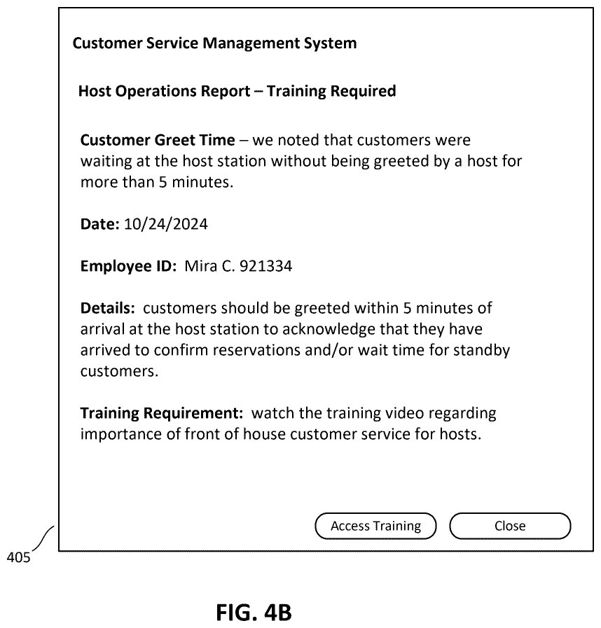

FIGS. 4A and 4B are diagrams providing examples of user interface 405 of an alerts and reporting application according to the techniques disclosed herein. The user interface 405 presents training suggestions determined by the training suggestion unit 190 of the inventory and personnel management platform 170. FIG. 4A provides an example training suggestion for a server and FIG. 4B provides an example training suggestion for a host. The training suggestions are not limited to the specific examples shown in FIGS. 4A and 4B. The training suggestion unit 190 can be configured to provide various types of training suggestions for members of staff in various roles. The training data suggestions can be sent to both the member of staff for which the training is suggested and their manager, so that the manager is aware of the suggested training and can follow up with the member of staff to ensure that they have completed the training and to avoid a reoccurrence of the issue that triggered the training recommendation.

FIGS. 5A and 5B are diagrams providing examples of user interface 510 for a point-of-sale terminal according to the techniques described herein. The POS terminal can be a portable POS terminal, or a stationary POS terminal as discussed in the preceding examples. FIG. 5A shows an example in which the user interface 510 shows the details of a returning customer. As discussed in the preceding examples, the customer service unit 193 identifies the customer using the video analysis module, obtains the customer information from the customer database 194 for repeat customers, and provides the customer information to the POS terminal for presentation on the POS terminal. As shown in FIG. 5A, the customer information can include an image of the customer, the customer's name (if known), preferred food and/or drinks that the customer typically orders, and notes that provide additional details of the customer's preferences. The notes can be manually entered by a member of staff and/or generated by the video analysis model or other AI models 174. FIG. 5B shows an example of the user interface 510 presenting customer service information for a table that includes multiple customers in a party. The user interface 510 enables the user to split the invoice for the customers into multiple invoices. Each invoice can be associated with one or more of the customers. The user interface also enables a user to click on or otherwise activate an image of a customer to cause the customer information to be displayed for the customer. The user interface also enables the user to enter order information (not shown) and to associate the order information with each of the customers.

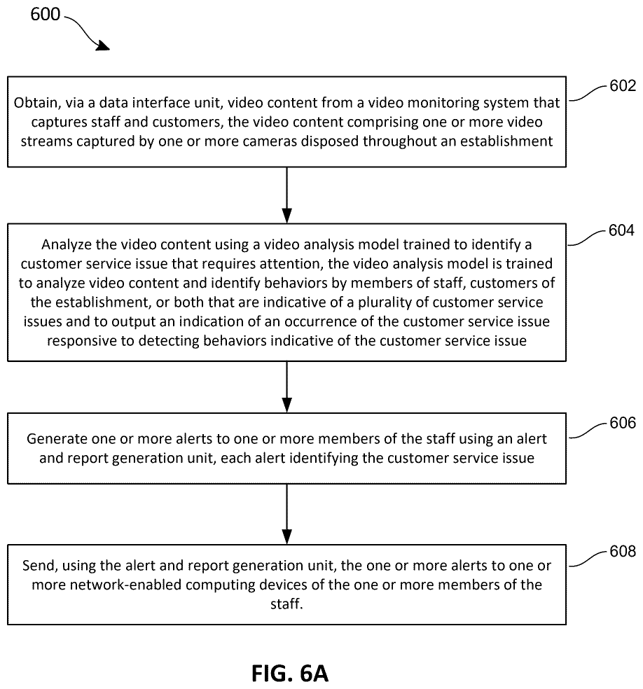

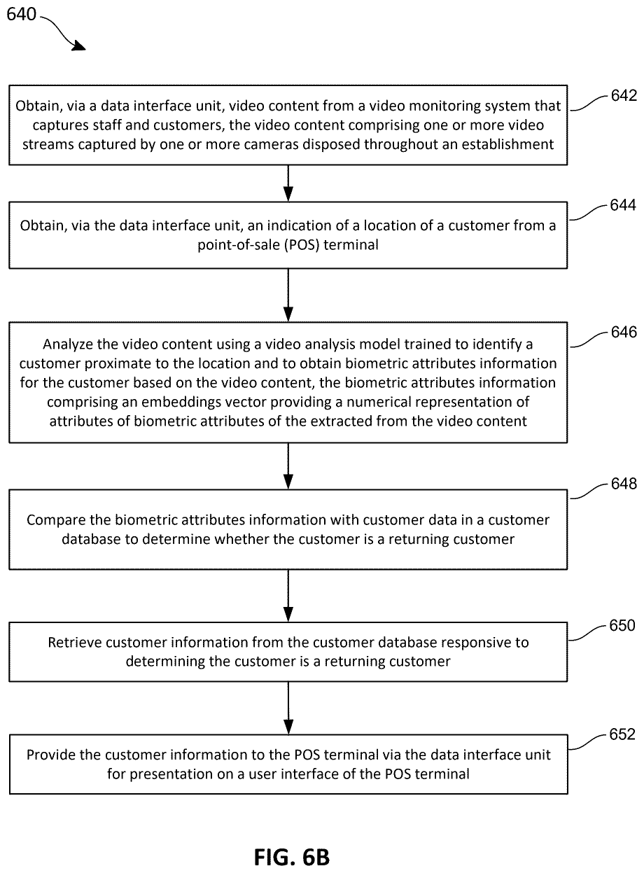

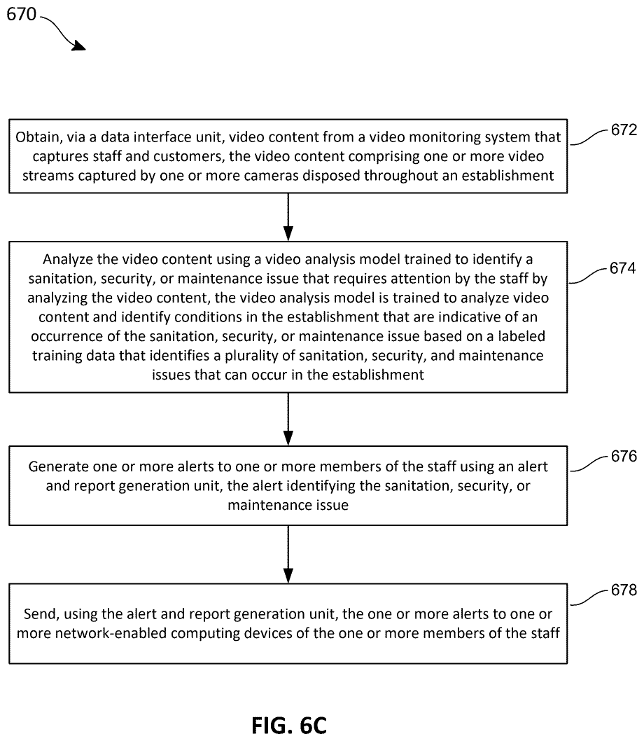

FIG. 6A is a flow chart of an example process 600 for managing inventory and personnel according to the techniques described herein. The process 600 utilize a video analysis model to analyze video content captured by video cameras disposed throughout a drinking, eating, and/or retail establishment to identify various types of customer service issues that need to be addressed by the staff. The process 600 can be implemented by the inventory and personnel management platform 170 discussed in the preceding examples.

The process 600 includes an operation 602 of obtaining, via a data interface unit, video content from a video monitoring system that captures staff and customers, the video content comprising one or more video streams captured by one or more cameras disposed throughout an establishment. The inventory and personnel management platform 170 obtains video streams from one or more video cameras from the video monitoring system 110.

The process 600 includes an operation 604 of analyzing the video content using a video analysis model trained to identify a customer service issue that requires attention. The video analysis model is trained to analyze video content and identify behaviors by members of staff, customers of the establishment, or both that are indicative of a plurality of customer service issues and to output an indication of an occurrence of the customer service issue responsive to detecting behaviors indicative of the customer service issue. Non-limiting examples of such customer service issues include but are not limited to the following: the video analysis model determines that a customer appears to be looking for a member of the staff to place an order; the video analysis model determines a customer has finished their food and/or drink and a member of staff should check with the customer to see whether the customer would like to order additional items; the video analysis model determines that empty plates and/or drinkware have not been cleared from a table for more than a threshold period of time; the video analysis model determines that food ordered by a customer has been prepared by a kitchen and is ready to be picked up and served to the customer; the video analysis model determines that there are discrepancies between items ordered via the point-of-sale system by a customer and items served to the customer. These are just a few examples of the types of customer service issues that may be detected by the video analysis model. The video analysis model can be trained to address additional types of customer service issues.

The process 600 includes an operation 606 of generating one or more alerts to one or more members of the staff using an alert and report generation unit, each alert identifying the customer service issue and an operation 608 of sending, using the alert and report generation unit, the one or more alerts to one or more network-enabled computing devices of the one or more members of the staff. The inventory and personnel management platform 170 analyzes the various information discussed above in substantially real time so that customer service issues can be identified and addressed as they are occurring. A technical benefit of this approach is that the inventory and personnel management platform 170 can identify customer issues that can negatively impact the customer experience and cause losses in revenue as these incidents are occurring or shortly thereafter to enable a member of staff or manager to address these issues. This provides a technical advantage, because a manager cannot constantly monitor the activity of every staff member at the restaurant and would be unlikely to detect such issues immediately.

FIG. 6B is a flow chart of an example process 640 for managing inventory and personnel according to the techniques described herein. The process 640 utilizes a video analysis model to analyze video content captured by video cameras disposed throughout a drinking, eating, and/or retail establishment to identify new and returning customers, to access customer information for returning customers, and to provide the customer information to a POS terminal associated with the POS system 120. The process 640 can be implemented by the inventory and personnel management platform 170 discussed in the preceding examples.

The process 640 includes an operation 642 of obtaining, via a data interface unit, video content from a video monitoring system that captures staff and customers, the video content comprising one or more video streams captured by one or more cameras disposed throughout an establishment. The inventory and personnel management platform 170 obtains video streams from one or more video cameras from the video monitoring system 110.

The process 640 includes an operation 644 of obtaining, via the data interface unit, an indication of a location of a customer from a point-of-sale (POS) terminal. The POS terminal can be a portable POS terminal that is carried by a host, wait staff, bartender, or other member of staff that enables a user to input food and/or drink orders, check the status of orders, receive alerts from the inventory and personnel management platform 170, present customer information for returning customers, and/or perform other such tasks. In such implementations, the location may be automatically provided to the POS system 120 and/or the inventory and personnel management platform 170 when the portable POS terminal is determined to be within a predetermined distance from a table or seat at the bar where a customer is located. In other implementations, the portable POS terminal presents a user interface that provides a control, which when clicked on or otherwise activated, causes the POS terminal to send the location of the POS terminal to the POS system 120 and/or the inventory and personnel management platform 170. In a non-limiting example, the user interface may include a map of the tables and/or bar seating in the establishment and the user selects a table or bar seat from this map to trigger the POS terminal to send the location of the selected table or bar set as the indication of the location. In other implementations, the POS terminal is a stationary POS terminal that is disposed at a fixed location in the establishment, such as but not limited to the POS terminals 220a, 220b, and 220c.

The process 640 includes an operation 646 of analyzing the video content using a video analysis model trained to identify a customer proximate to the location and to obtain biometric attributes information for the customer based on the video content, the biometric attributes information comprising an embeddings vector providing a numerical representation of attributes of biometric attributes of the extracted from the video content. As discussed in the preceding examples, the video analysis model can generate biometric attributes information for the customer identified in the video. These biometric attributes can be based on physical characteristics of the user, such as but not limited to facial features for facial recognition, body shape and/or size, voice attributes for voice recognition, and/or other attributes of the customer that can be used to identify the customer. In some implementations, the biometric attributes are represented by embeddings comprising a vector of numerical values that represent the biometric attributes of the customer. The customer information stored in the customer database 194 is associated with the embeddings that were determined at the time that the customer information was added to the customer database 194 and/or updated on a subsequent visit by the customer.

The process 640 includes an operation 650 of retrieving customer information from the customer database responsive to determining the customer is a returning customer and an operation 652 of providing the customer information to the POS terminal via the data interface unit for presentation on a user interface of the POS terminal. As discussed in the preceding examples, the inventory and personnel management platform 170 accesses customer information from the customer database 194 and provides the customer information to the POS terminal for presentation to the user. Examples of such a user interface are shown in FIGS. 5A and 5B. A technical benefit of this approach is that the inventory and personnel management platform 170 analyzes the video content captured by the video cameras and identifies repeat customers and automatically loads the customer information, which includes customer preference information. The customer preference information includes items that the customer has ordered in the past. This information can be used to provide a personalized experience for the customer and increase customer engagement, because the staff can suggest items that the customer has ordered in the past and/or make recommendations for other items that the customer may wish to order.

FIG. 6C is a flow chart of an example process 670 for managing inventory and personnel according to the techniques described herein. The process 670 utilize a video analysis model to analyze video content captured by video cameras disposed throughout a drinking, eating, and/or retail establishment to identify various types of sanitation, security, and/or maintenance issues. The process 670 can be implemented by the inventory and personnel management platform 170 discussed in the preceding examples.

The process 670 includes an operation 672 of obtaining, via a data interface unit, video content from a video monitoring system that captures staff and customers, the video content comprising one or more video streams captured by one or more cameras disposed throughout an establishment. The inventory and personnel management platform 170 obtains video streams from one or more video cameras from the video monitoring system 110.

The process 670 includes an operation 674 of analyzing the video content using a video analysis model trained to identify a sanitation, security, or maintenance issue that requires attention by the staff by analyzing the video content, the video analysis model is trained to analyze video content and identify conditions in the establishment that are indicative of an occurrence of the sanitation, security, or maintenance issue based on a labeled training data that identifies a plurality of sanitation, security, and maintenance issues that can occur in the establishment. As discussed in the preceding examples, the inventory and personnel management platform 170 can recognize various types of sanitation, security, or maintenance issues that may occur in the establishment. Non-limiting examples of such sanitation, security, or maintenance issues include but are not limited to the following: the video analysis model determining that a member of the staff or customers has taken property belonging to the establishment or a customer without authorization. The video analysis model determining that furniture or fixture of the establishment is damaged and presents a safety hazard to the staff or customers of the establishment; the video analysis model determining that a food preparation area or food serving area of the establishment is in an unsanitary condition that can pose a health hazard to the staff or customers of the establishment; and/or the video analysis model determining that a lighting condition or sound level of the establishment fail to satisfy a comfort threshold. These are just a few examples of the types of sanitation, security, or maintenance issues that may be detected by the video analysis model. The video analysis model can be trained to address additional types of sanitation, security, or maintenance issues.

The process 670 includes an operation 676 of generating one or more alerts to one or more members of the staff using an alert and report generation unit, the alert identifying the sanitation, security, or maintenance issue and an operation 678 of sending, using the alert and report generation unit, the one or more alerts to one or more network-enabled computing devices of the one or more members of the staff. The inventory and personnel management platform 170 analyzes the information discussed above in substantially real time so that sanitations issues, security issues, and/or maintenance issues are identified as they are occurring. A technical benefit of this approach is that the inventory and personnel management platform 170 can alert the appropriate members of the staff to address these issues to avoid a customer or member of staff from becoming ill or injured and/or to avoid theft of items by staff or customers or customer utilizing counterfeit money to pay an invoice. This provides a technical advantage, because a manager cannot constantly monitor the activity of every staff member at the restaurant and would be unlikely to detect such issues immediately.

The detailed examples of systems, devices, and techniques described in connection with FIGS. 1-6C are presented herein for illustration of the disclosure and its benefits. Such examples of use should not be construed to be limitations on the logical process embodiments of the disclosure, nor should variations of user interface methods from those described herein be considered outside the scope of the present disclosure. It is understood that references to displaying or presenting an item (such as, but not limited to, presenting an image on a display device, presenting audio via one or more loudspeakers, and/or vibrating a device) include issuing instructions, commands, and/or signals causing, or reasonably expected to cause, a device or system to display or present the item. In some embodiments, various features described in FIGS. 1-6C are implemented in respective modules, which may also be referred to as, and/or include, logic, components, units, and/or mechanisms. Modules may constitute either software modules (for example, code embodied on a machine-readable medium) or hardware modules.

In some examples, a hardware module may be implemented mechanically, electronically, or with any suitable combination thereof. For example, a hardware module may include dedicated circuitry or logic that is configured to perform certain operations. For example, a hardware module may include a special-purpose processor, such as a field-programmable gate array (FPGA) or an Application Specific Integrated Circuit (ASIC). A hardware module may also include programmable logic or circuitry that is temporarily configured by software to perform certain operations and may include a portion of machine-readable medium data and/or instructions for such configuration. For example, a hardware module may include software encompassed within a programmable processor configured to execute a set of software instructions. It will be appreciated that the decision to implement a hardware module mechanically, in dedicated and permanently configured circuitry, or in temporarily configured circuitry (for example, configured by software) may be driven by cost, time, support, and engineering considerations.

Accordingly, the phrase “hardware module” should be understood to encompass a tangible entity capable of performing certain operations and may be configured or arranged in a certain physical manner, be that an entity that is physically constructed, permanently configured (for example, hardwired), and/or temporarily configured (for example, programmed) to operate in a certain manner or to perform certain operations described herein. As used herein, “hardware-implemented module”refers to a hardware module. Considering examples in which hardware modules are temporarily configured (for example, programmed), each of the hardware modules need not be configured or instantiated at any one instance in time. For example, where a hardware module includes a programmable processor configured by software to become a special-purpose processor, the programmable processor may be configured as respectively different special-purpose processors (for example, including different hardware modules) at different times. Software may accordingly configure a processor or processors, for example, to constitute a particular hardware module at one instance of time and to constitute a different hardware module at a different instance of time. A hardware module implemented using one or more processors may be referred to as being “processor implemented” or “computer implemented.”

Hardware modules can provide information to, and receive information from, other hardware modules. Accordingly, the described hardware modules may be regarded as being communicatively coupled. Where multiple hardware modules exist contemporaneously, communications may be achieved through signal transmission (for example, over appropriate circuits and buses) between or among two or more of the hardware modules. In embodiments in which multiple hardware modules are configured or instantiated at different times, communications between such hardware modules may be achieved, for example, through the storage and retrieval of information in memory devices to which the multiple hardware modules have access. For example, one hardware module may perform an operation and store the output in a memory device, and another hardware module may then access the memory device to retrieve and process the stored output.

In some examples, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by, and/or among, multiple computers (as examples of machines including processors), with these operations being accessible via a network (for example, the Internet) and/or via one or more software interfaces (for example, an application program interface (API)). The performance of certain of the operations may be distributed among the processors, not only residing within a single machine, but deployed across several machines. Processors or processor-implemented modules may be in a single geographic location (for example, within a home or office environment, or a server farm), or may be distributed across multiple geographic locations.

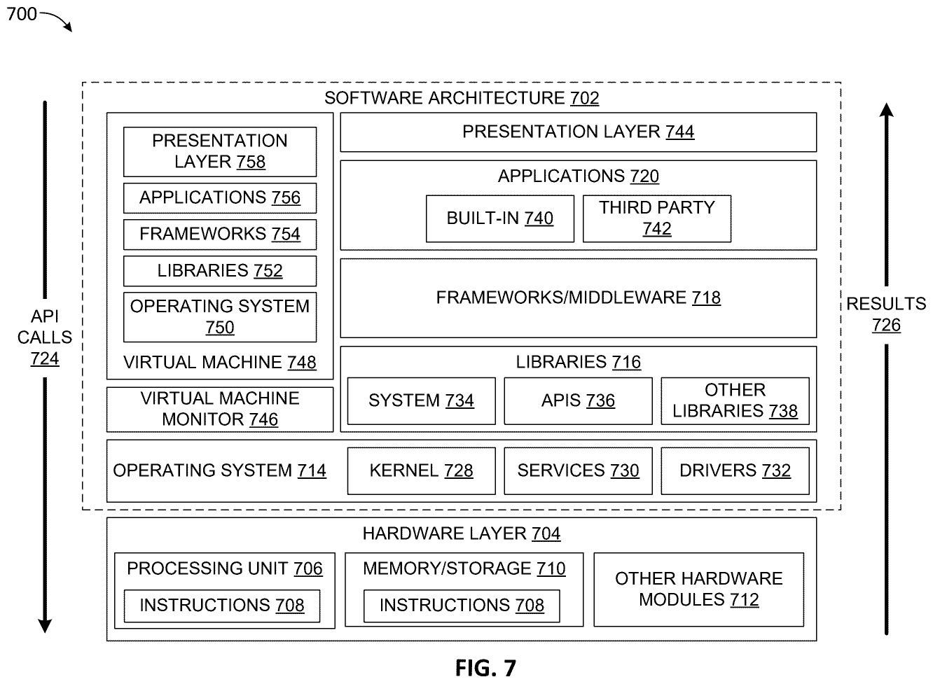

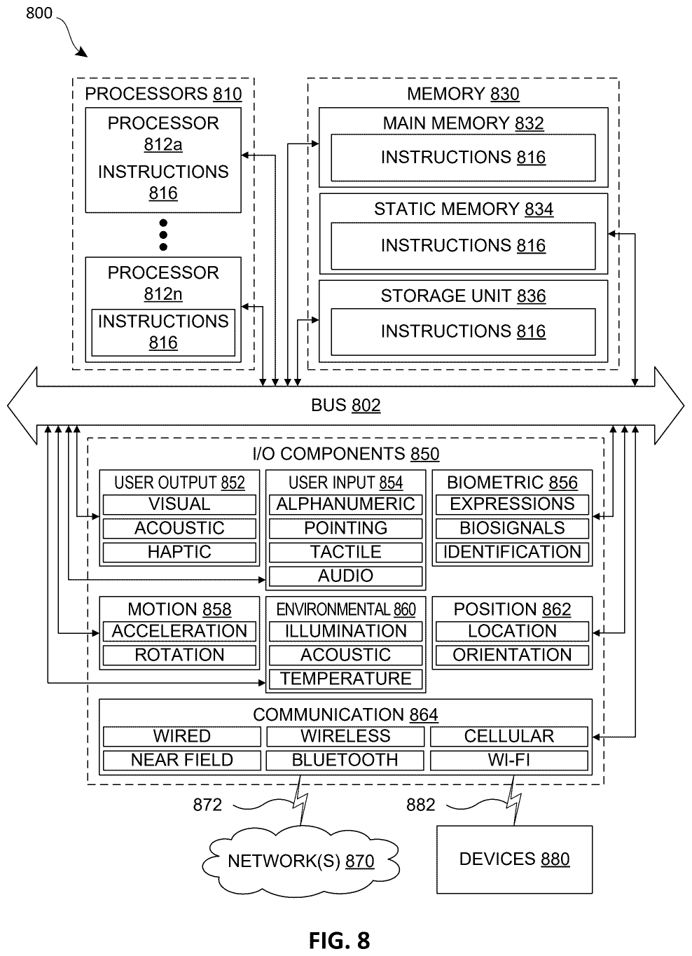

FIG. 7 is a block diagram 700 illustrating an example software architecture 702, various portions of which may be used in conjunction with various hardware architectures herein described, which may implement any of the above-described features. FIG. 7 is a non-limiting example of a software architecture, and it will be appreciated that many other architectures may be implemented to facilitate the functionality described herein. The software architecture 702 may execute on hardware such as a machine 800 of FIG. 8 that includes, among other things, processors 810, memory/storage 830, and input/output (I/O) components 850. A representative hardware layer 704 is illustrated and can represent, for example, the machine 800 of FIG. 8. The representative hardware layer 704 includes a processing unit 706 and associated executable instructions 708. The executable instructions 708 represent executable instructions of the software architecture 702, including implementation of the methods, modules and so forth described herein. The hardware layer 704 also includes a memory/storage 710, which also includes the executable instructions 708 and accompanying data. The hardware layer 704 may also include other hardware modules 712. Instructions 708 held by processing unit 706 may be portions of instructions 708 held by the memory/storage 710.

The example software architecture 702 may be conceptualized as layers, each providing various functionality. For example, the software architecture 702 may include layers and components such as an operating system (OS) 714, libraries 716, frameworks/middleware 718, applications 720, and a presentation layer 744. Operationally, the applications 720 and/or other components within the layers may invoke API calls 724 to other layers and receive corresponding results 726. The layers illustrated are representative in nature and other software architectures may include additional or different layers. For example, some mobile or special purpose operating systems may not provide the frameworks/middleware 718.

The OS 714 may manage hardware resources and provide common services. The OS 714 may include, for example, a kernel 728, services 730, and drivers 732. The kernel 728 may act as an abstraction layer between the hardware layer 704 and other software layers. For example, the kernel 728 may be responsible for memory management, processor management (for example, scheduling), component management, networking, security settings, and so on. The services 730 may provide other common services for the other software layers. The drivers 732 may be responsible for controlling or interfacing with the underlying hardware layer 704. For instance, the drivers 732 may include display drivers, camera drivers, memory/storage drivers, peripheral device drivers (for example, via Universal Serial Bus (USB)), network and/or wireless communication drivers, audio drivers, and so forth depending on the hardware and/or software configuration.

The libraries 716 may provide a common infrastructure that may be used by the applications 720 and/or other components and/or layers. The libraries 716 typically provide functionality for use by other software modules to perform tasks, rather than rather than interacting directly with the OS 714. The libraries 716 may include system libraries 734 (for example, C standard library) that may provide functions such as memory allocation, string manipulation, file operations. In addition, the libraries 716 may include API libraries 736 such as media libraries (for example, supporting presentation and manipulation of image, sound, and/or video data formats), graphics libraries (for example, an OpenGL library for rendering 2D and 3D graphics on a display), database libraries (for example, SQLite or other relational database functions), and web libraries (for example, WebKit that may provide web browsing functionality). The libraries 716 may also include a wide variety of other libraries 738 to provide many functions for applications 720 and other software modules.

The frameworks/middleware 718 provide a higher-level common infrastructure that may be used by the applications 720 and/or other software modules. For example, the frameworks/middleware 718 may provide various graphic user interface (GUI) functions, high-level resource management, or high-level location services. The frameworks/middleware 718 may provide a broad spectrum of other APIs for applications 720 and/or other software modules.

The applications 720 include built-in applications 740 and/or third-party applications 742. Examples of built-in applications 740 may include, but are not limited to, a contacts application, a browser application, a location application, a media application, a messaging application, and/or a game application. Third-party applications 742 may include any applications developed by an entity other than the vendor of the particular platform. The applications 720 may use functions available via OS 714, libraries 716, frameworks/middleware 718, and presentation layer 744 to create user interfaces to interact with users.

Some software architectures use virtual machines, as illustrated by a virtual machine 748. The virtual machine 748 provides an execution environment where applications/modules can execute as if they were executing on a hardware machine (such as the machine 800 of FIG. 8, for example). The virtual machine 748 may be hosted by a host OS (for example, OS 714) or hypervisor, and may have a virtual machine monitor 746 which manages operation of the virtual machine 748 and interoperation with the host operating system. A software architecture, which may be different from software architecture 702 outside of the virtual machine, executes within the virtual machine 748 such as an OS 750, libraries 752, frameworks 754, applications 756, and/or a presentation layer 758.

FIG. 8 is a block diagram illustrating components of an example machine 800 configured to read instructions from a machine-readable medium (for example, a machine-readable storage medium) and perform any of the features described herein. The example machine 800 is in a form of a computer system, within which instructions 816 (for example, in the form of software components) for causing the machine 800 to perform any of the features described herein may be executed. As such, the instructions 816 may be used to implement modules or components described herein. The instructions 816 cause unprogrammed and/or unconfigured machine 800 to operate as a particular machine configured to carry out the described features. The machine 800 may be configured to operate as a standalone device or may be coupled (for example, networked) to other machines. In a networked deployment, the machine 800 may operate in the capacity of a server machine or a client machine in a server-client network environment, or as a node in a peer-to-peer or distributed network environment. Machine 800 may be embodied as, for example, a server computer, a client computer, a personal computer (PC), a tablet computer, a laptop computer, a netbook, a set-top box (STB), a gaming and/or entertainment system, a smart phone, a mobile device, a wearable device (for example, a smart watch), and an Internet of Things (IoT) device. Further, although only a single machine 800 is illustrated, the term “machine” includes a collection of machines that individually or jointly execute the instructions 816.

The machine 800 may include processors 810, memory/storage 830, and I/O components 850, which may be communicatively coupled via, for example, a bus 802. The bus 802 may include multiple buses coupling various elements of machine 800 via various bus technologies and protocols. In an example, the processors 810 (including, for example, a central processing unit (CPU), a graphics processing unit (GPU), a digital signal processor (DSP), an ASIC, or a suitable combination thereof) may include one or more processors 812a to 812n that may execute the instructions 816 and process data. In some examples, one or more processors 810 may execute instructions provided or identified by one or more other processors 810. The term “processor” includes a multi-core processor including cores that may execute instructions contemporaneously. Although FIG. 8 shows multiple processors, the machine 800 may include a single processor with a single core, a single processor with multiple cores (for example, a multi-core processor), multiple processors each with a single core, multiple processors each with multiple cores, or any combination thereof. In some examples, the machine 800 may include multiple processors distributed among multiple machines.

The memory/storage 830 may include a main memory 832, a static memory 834, or other memory, and a storage unit 836, both accessible to the processors 810 such as via the bus 802. The storage unit 836 and memory 832, 834 store instructions 816 embodying any one or more of the functions described herein. The memory/storage 830 may also store temporary, intermediate, and/or long-term data for processors 810. The instructions 816 may also reside, completely or partially, within the memory 832, 834, within the storage unit 836, within at least one of the processors 810 (for example, within a command buffer or cache memory), within memory at least one of I/O components 850, or any suitable combination thereof, during execution thereof. Accordingly, the memory 832, 834, the storage unit 836, memory in processors 810, and memory in I/O components 850 are examples of machine-readable media.

As used herein, “machine-readable medium” refers to a device able to temporarily or permanently store instructions and data that cause machine 800 to operate in a specific fashion, and may include, but is not limited to, random-access memory (RAM), read-only memory (ROM), buffer memory, flash memory, optical storage media, magnetic storage media and devices, cache memory, network-accessible or cloud storage, other types of storage and/or any suitable combination thereof. The term “machine-readable medium” applies to a single medium, or combination of multiple media, used to store instructions (for example, instructions 816) for execution by a machine 800 such that the instructions, when executed by one or more processors 810 of the machine 800, cause the machine 800 to perform and one or more of the features described herein. Accordingly, a “machine-readable medium” may refer to a single storage device, as well as “cloud-based” storage systems or storage networks that include multiple storage apparatus or devices. The term “machine-readable medium” excludes signals per se.

The I/O components 850 may include a wide variety of hardware components adapted to receive input, provide output, produce output, transmit information, exchange information, capture measurements, and so on. The specific I/O components 850 included in a particular machine will depend on the type and/or function of the machine. For example, mobile devices such as mobile phones may include a touch input device, whereas a headless server or IoT device may not include such a touch input device. The particular examples of I/O components illustrated in FIG. 8 are in no way limiting, and other types of components may be included in machine 800. The grouping of I/O components 850 are merely for simplifying this discussion, and the grouping is in no way limiting. In various examples, the I/O components 850 may include user output components 852 and user input components 854. User output components 852 may include, for example, display components for displaying information (for example, a liquid crystal display (LCD) or a projector), acoustic components (for example, speakers), haptic components (for example, a vibratory motor or force-feedback device), and/or other signal generators. User input components 854 may include, for example, alphanumeric input components (for example, a keyboard or a touch screen), pointing components (for example, a mouse device, a touchpad, or another pointing instrument), and/or tactile input components (for example, a physical button or a touch screen that provides location and/or force of touches or touch gestures) configured for receiving various user inputs, such as user commands and/or selections.

In some examples, the I/O components 850 may include biometric components 856, motion components 858, environmental components 860, and/or position components 862, among a wide array of other physical sensor components. The biometric components 856 may include, for example, components to detect body expressions (for example, facial expressions, vocal expressions, hand or body gestures, or eye tracking), measure biosignals (for example, heart rate or brain waves), and identify a person (for example, via voice-, retina-, fingerprint-, and/or facial-based identification). The motion components 858 may include, for example, acceleration sensors (for example, an accelerometer) and rotation sensors (for example, a gyroscope). The environmental components 860 may include, for example, illumination sensors, temperature sensors, humidity sensors, pressure sensors (for example, a barometer), acoustic sensors (for example, a microphone used to detect ambient noise), proximity sensors (for example, infrared sensing of nearby objects), and/or other components that may provide indications, measurements, or signals corresponding to a surrounding physical environment. The position components 862 may include, for example, location sensors (for example, a Global Position System (GPS) receiver), altitude sensors (for example, an air pressure sensor from which altitude may be derived), and/or orientation sensors (for example, magnetometers).

The I/O components 850 may include communication components 864, implementing a wide variety of technologies operable to couple the machine 800 to network(s) 870 and/or device(s) 880 via respective communicative couplings 872 and 882. The communication components 864 may include one or more network interface components or other suitable devices to interface with the network(s) 870. The communication components 864 may include, for example, components adapted to provide wired communication, wireless communication, cellular communication, Near Field Communication (NFC), Bluetooth communication, Wi-Fi, and/or communication via other modalities. The device(s) 880 may include other machines or various peripheral devices (for example, coupled via USB).

In some examples, the communication components 864 may detect identifiers or include components adapted to detect identifiers. For example, the communication components 864 may include Radio Frequency Identification (RFID) tag readers, NFC detectors, optical sensors (for example, one-or multi-dimensional bar codes, or other optical codes), and/or acoustic detectors (for example, microphones to identify tagged audio signals). In some examples, location information may be determined based on information from the communication components 864, such as, but not limited to, geo-location via Internet Protocol (IP) address, location via Wi-Fi, cellular, NFC, Bluetooth, or other wireless station identification and/or signal triangulation.

In the preceding detailed description, numerous specific details are set forth by way of examples in order to provide a thorough understanding of the relevant teachings. However, it should be apparent that the present teachings may be practiced without such details. In other instances, well known methods, procedures, components, and/or circuitry have been described at a relatively high-level, without detail, in order to avoid unnecessarily obscuring aspects of the present teachings.

While various embodiments have been described, the description is intended to be exemplary, rather than limiting, and it is understood that many more embodiments and implementations are possible that are within the scope of the embodiments. Although many possible combinations of features are shown in the accompanying figures and discussed in this detailed description, many other combinations of the disclosed features are possible. Any feature of any embodiment may be used in combination with or substituted for any other feature or element in any other embodiment unless specifically restricted. Therefore, it will be understood that any of the features shown and/or discussed in the present disclosure may be implemented together in any suitable combination. Accordingly, the embodiments are not to be restricted except in light of the attached claims and their equivalents. Also, various modifications and changes may be made within the scope of the attached claims.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element. Furthermore, subsequent limitations referring back to “said element” or “the element” performing certain functions signifies that “said element” or “the element” alone or in combination with additional identical elements in the process, method, article, or apparatus are capable of performing all of the recited functions.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that the claims require more features than are expressly recited in each claim. Rather, as the following claims reflect, inventive subject matter lies in less than all features of a single disclosed example. Thus, the following claims are hereby incorporated into the Detailed Description, with each claim standing on its own as a separately claimed subject matter.

What is claimed is:

1. A data processing system for analyzing video content using machine learning models to automatically identify customer service issues, the data processing system comprising:
a processor; and
a memory storing executable instructions that, when executed, cause the processor alone or in combination with other processors to perform operations of:
obtaining, via a data interface unit, video content from a video monitoring system that captures staff and customers, the video content comprising one or more video streams captured by one or more cameras disposed throughout an establishment;
analyzing the video content using a video analysis model trained to identify a customer service issue that requires attention, wherein the video analysis model is trained to analyze video content and identify behaviors by members of staff, customers of the establishment, or both that are indicative of a one or more customer service issues and to output an indication of an occurrence of the customer service issue responsive to detecting behaviors indicative of the customer service issue;
generating one or more alerts to one or more members of the staff using an alert and report generation unit, each alert identifying the customer service issue; and
sending, using the alert and report generation unit, the one or more alerts to one or more network-enabled computing devices of the one or more members of the staff.

2. The data processing system of claim 1, wherein analyzing the video content using the video analysis model trained to identify the customer service issue further comprises:
determining that a customer appears to be looking for a member of the staff to place an order or make a request,
wherein generating the one or more alerts comprises generating an alert to the one or more members of the staff indicating that a member of the staff should check on the customer.

3. The data processing system of claim 1, wherein analyzing the video content using the video analysis model trained to identify the customer service issue further comprises:
determining that a customer has finished their food, drink, or both food and drink,
wherein generating the one or more alerts comprises generating an alert to the one or more members of the staff indicating that the one or more members of the staff should check to see whether the customer would like to order additional food, drinks, or both food and drinks.

4. The data processing system of claim 1, wherein analyzing the video content using the video analysis model trained to identify the customer service issue further comprises:
determining that plates, drinkware, or both plates and drinkware have not been cleared for more than a threshold period,
wherein generating the one or more alerts comprises generating an alert to the one or more members of the staff indicating that the plates, drinkware, or both plates and drinkware should be cleared.

5. The data processing system of claim 1, wherein analyzing the video content using the video analysis model trained to identify the customer service issue further comprises:
determining that food ordered by a customer has been prepared by a kitchen and is ready to be picked up and served to the customer,
wherein generating the one or more alerts comprises generating an alert to the one or more members of the staff indicating that the food is ready to be picked up and served to the customer.

6. The data processing system of claim 1, wherein a analyzing the video content using the video analysis model trained to identify the customer service issue further comprises:
determining that a customer appears to be looking for a member of the staff to place an order or make a request,
wherein generating the one or more alerts comprises generating an alert to the one or more members of the staff indicating that a member of the staff should check on the customer.

7. The data processing system of claim 1, wherein the video analysis model is a multimodal model configured to receive invoice information from a point-of-sale system as well as the video content as inputs, and wherein analyzing the video content using a video analysis model trained to identify a customer service issue further comprises:
analyzing items ordered via the point-of-sale system by a customer and items served to the customer to identify discrepancies between the items ordered and items served to the customer,
wherein generating the one or more alerts comprises generating an alert to the one or more members of the staff identifying the discrepancies between the items ordered and the items served to the customer.

8. The data processing system of claim 1, wherein the memory further includes instructions configured to cause the processor alone or in combination with other processors to perform operations of:
generating a training recommendation based on the one or more alerts by analyzing the one or more alerts with a training suggestion unit; and
sending the training recommendation to at least one member of the staff, the training recommendation recommending training to avoid a reoccurrence of the customer service issue.

9. A data processing system for analyzing video content using machine learning models to automatically identify customers, the data processing system comprising:
a processor; and
a memory storing executable instructions that, when executed, cause the processor alone or in combination with other processors to perform operations of:
obtaining, via a data interface unit, video content from a video monitoring system that captures staff and customers, the video content comprising one or more video streams captured by one or more cameras disposed throughout an establishment;
obtaining, via the data interface unit, an indication of a location of a customer from a point-of-sale (POS) terminal;
analyzing the video content using a video analysis model trained to identify a customer proximate to the location and to obtain biometric attributes information for the customer based on the video content, the biometric attributes information comprising an embeddings vector providing a numerical representation of attributes of biometric attributes of the extracted from the video content;
comparing the biometric attributes information with customer data in a customer database to determine whether the customer is a returning customer;
retrieving customer information from the customer database responsive to determining the customer is a returning customer; and
providing the customer information to the POS terminal via the data interface unit for presentation on a user interface of the POS terminal.

10. The data processing system of claim 9, wherein the customer information includes an image of the customer, the customer information further comprising customer preference information indicating items typically ordered by the customer.

11. The data processing system of claim 10, wherein the memory further includes instructions configured to cause the processor alone or in combination with other processors to perform operations of:
creating a customer information data structure for the customer in the customer database responsive to determining that the customer is a new customer;
associating an image of the customer extracted from the video content with the customer information data structure; and
populating the customer information data structure with timestamp information indicating when the customer information data structure was created.

12. The data processing system of claim 10, wherein the memory further includes instructions configured to cause the processor alone or in combination with other processors to perform operations of:
obtaining, via the data interface unit, invoice information for items ordered by the customer from the POS terminal;
updating the customer information in the customer database with information identifying the items ordered by the customer; and
determining the customer preference information based at least in part on the items ordered by the customer.

13. The data processing system of claim 10, wherein the video analysis model determines that the customer is associated with a party comprising the customer and at least one other customer, and, wherein the memory further includes instructions configured to cause the processor alone or in combination with other processors to perform operations of:
comparing the biometric attributes information of each respective customer of the at least one other customer with customer data in a customer database to determine that the respective customer is a returning customer;
retrieving customer information from the customer database responsive to determining the respective customer is a returning customer; and
providing the customer information for the customer and each respective customer of the at least one other customer to the POS terminal via the data interface unit for presentation on the user interface of the POS terminal.

14. The data processing system of claim 13, wherein the memory further includes instructions configured to cause the processor alone or in combination with other processors to perform operations of:
presenting a user interface of the POS terminal that enables an invoice to be split into multiple invoices, wherein each invoice is associated with one or more customers.

15. The data processing system of claim 13, wherein the POS terminal is a portable POS terminal, and wherein obtaining the location comprises receiving a location of the portable POS terminal within the establishment.

16. A data processing system for analyzing video content using machine learning models to automatically identify sanitation, security, and maintenance issues, the data processing system comprising:
a processor; and
a memory storing executable instructions that, when executed, cause the processor alone or in combination with other processors to perform operations of:
obtaining, via a data interface unit, video content from a video monitoring system that captures staff and customers, the video content comprising one or more video streams captured by one or more cameras disposed throughout an establishment;
analyzing the video content using a video analysis model trained to identify a sanitation, security, or maintenance issue that requires attention by the staff by analyzing the video content, wherein the video analysis model is trained to analyze video content and identify conditions in the establishment that are indicative of an occurrence of the sanitation, security, or maintenance issue based on a labeled training data that identifies a plurality of sanitation, security, and maintenance issues that can occur in the establishment;
generating one or more alerts to one or more members of the staff using an alert and report generation unit, the alert identifying the sanitation, security, or maintenance issue; and
sending, using the alert and report generation unit, the one or more alerts to one or more network-enabled computing devices of the one or more members of the staff.

17. The data processing system of claim 16, wherein analyzing the video content using a video analysis model trained to identify a sanitation, security, or maintenance issue that requires attention by the staff by analyzing the video content further comprises:
determining that a member of the staff has taken property belonging to the establishment or a customer without authorization.

18. The data processing system of claim 16, wherein analyzing the video content using a video analysis model trained to identify a sanitation, security, or maintenance issue that requires attention by the staff by analyzing the video content further comprises:
determining that furniture or fixture of the establishment is damaged and presents a safety hazard to the staff or customers of the establishment.

19. The data processing system of claim 16, wherein analyzing the video content using a video analysis model trained to identify a sanitation, security, or maintenance issue that requires attention by the staff by analyzing the video content further comprises:
determining that a food preparation area or food serving area of the establishment is in an unsanitary condition that can pose a health hazard to the staff or customers of the establishment.

20. The data processing system of claim 16, wherein analyzing the video content using a video analysis model trained to identify a sanitation, security, or maintenance issue that requires attention by the staff by analyzing the video content further comprises:
determining that a lighting condition or sound level of the establishment fail to satisfy a comfort threshold.
